(19) United States
(12) Patent Application Publication
(10) Pub. No.: US 2003/0195727 A1
(43) Pub. Date: Oct. 16, 2003

(54) Simulation method and simulation system

(76) Inventors: Osamu Kubo, Hitachi (JP); Takeshi Yokota, Hitachi (JP); Yasuhiro Kobayashi, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/395,056

(22) Filed: Mar. 25, 2003

(30) Foreign Application Priority Data
Apr. 15, 2002 (JP) 2002-112348

(51) Int. Cl. G06F 17/10

(52) U.S. Cl. 703/2

(57) ABSTRACT

An object of the present invention is to provide a simulation method and a simulation system capable of performing a highly accurate simulation even when the indices related to the index to be simulated change with time (each simulation execution time point).

To accomplish the above object, the present invention calculates evaluation values each indicating the association degree of one of a plurality of indices with an index to be simulated at each simulation execution time point, and selects indices (closely) related to the index to be simulated based on the calculated evaluation values.

### BACKGROUND OF THE INVENTION

The present invention relates to a simulation method and a simulation system which simulate an index to be simulated by use of a computer based on received time-series data of a plurality of indices, and output the simulation results.

Conventional simulation methods and simulation systems simulate an index to be simulated by performing the following steps: Indices related to the index to be simulated are predetermined; the parameters necessary for simulating the index to be simulated are calculated using the predetermined related indices; and the index to be simulated is simulated using the calculated parameters.

As described above, according to the prior art technique, indices used for simulation of an index to be simulated are predetermined as related indices. Therefore, the same predetermined related indices must continue to be used even when the relationships between the related indices and the index to be simulated change with time (each simulation execution time point). This means that if the indices (closely) related to the index to be simulated change with time (each simulation execution time point), the problem of reduced simulation accuracy occurs.

It is, therefore, an object of the present invention to provide a simulation method and a simulation system capable of performing a highly accurate simulation even when the indices (closely) related to an index to be simulated change with time (each simulation execution time point).

### SUMMARY OF THE INVENTION

According to one aspect, the present invention calculates evaluation values each indicating the association degree of one of a plurality of indices with an index to be simulated at each simulation execution time point, and selects indices (closely) related to the index to be simulated based on the calculated evaluation values.

Therefore, according to the present invention, a highly accurate simulation can be performed even when the indices related to the index to be simulated change with time (each simulation execution time point).

### BRIEF DESCRIPTION OF THE DRAWINGS

FIG. 1 is a diagram showing a simulation method or a simulation system according to an embodiment of the present invention;

FIG. 2 is a diagram showing a first embodiment of the evaluation value calculation process 0101 shown in FIG. 1;

FIG. 3 is a diagram showing a second embodiment of the evaluation value calculation process 0101 shown in FIG. 1;

FIG. 4 is a diagram showing an embodiment of the index time-series data 0112 shown in FIGS. 1 to 3.

FIG. 5 is a diagram showing a first embodiment of the index evaluation value 0221 shown in FIG. 2 or the index evaluation value 0321 shown in FIG. 3;

FIG. 6 is a diagram showing a second embodiment of the index evaluation value 0221 shown in FIG. 2 or the index evaluation value 0321 shown in FIG. 3;

FIG. 7 is a diagram showing a first embodiment of the index selection process 0102 shown in FIG. 1;

FIG. 8 is a diagram showing a second embodiment of the index selection process 0102 shown in FIG. 1;

FIG. 9 is a diagram showing an embodiment of the parameters estimation process 0103 shown in FIG. 1.

FIG. 10 is a diagram showing an embodiment of the simulation process 0104 shown in FIG. 1;

FIG. 11 is a diagram showing an embodiment of the simulation results 0121 shown in FIG. 1;

FIG. 12 is a diagram showing a first embodiment of a simulation system using the simulation method shown in FIG. 1;

FIG. 13 is a diagram showing a second embodiment of the simulation system using the simulation method shown in FIG. 1;

FIG. 14 is a diagram showing a third embodiment of the simulation system using the simulation method shown in FIG. 1;

FIG. 15 is a diagram showing a fourth embodiment of the simulation system using the simulation method shown in FIG. 1;

FIG. 16 is a diagram showing a fifth embodiment of the simulation system using the simulation method shown in FIG. 1; and

FIG. 17 is a diagram showing a sixth embodiment of the simulation system using the simulation method shown in FIG. 1.

### DETAILED DESCRIPTION OF THE PREFERRED EMBODIMENTS

Preferred embodiments of the present invention will be described with reference to the accompanying drawings.

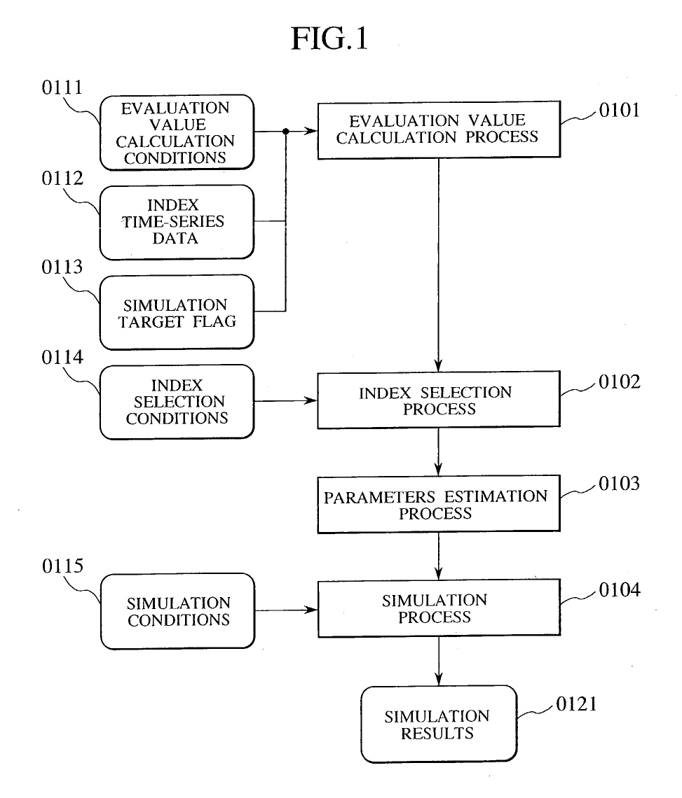

FIG. 1 shows a simulation method or a simulation system according to an embodiment of the present invention.

Referring to FIG. 1, the simulation method comprises the steps of: calculating evaluation values each indicating the association degree of one of a plurality of indices with a target index by use of an evaluation value calculation process 0101, the plurality of indices not including the target index; from among the plurality of indices not including the target index, selecting indices (related indices) to be used for simulation of the target index by use of an index selection process 0102; estimating (calculating) the parameters necessary for the simulation of the target index by use of a parameters estimation (calculation) process 0103; and simulating the target index by use of a simulation process 0104, outputting the results as simulation results 0121.

More specifically, the evaluation value calculation process 0101 receives output from an evaluation value calculation conditions (section) 0111, a time-series data (section) 0112, and a simulation target flag (section) 0113. The output from the evaluation value calculation conditions (section) 0111 specifies a specific past period (for example, the last one year, etc.). The time-series data (section) 0112 stores (data of) indices related to an index to be simulated (hereinafter referred to as an objective index or a target index) which changes with time. For example, suppose that the simulation target field is the electric power market. In such a case, examples of the indices are such items as price, demand, and supply. Therefore, the output from the time-series data (section) 0112 may be data of one of the price, demand, and supply. The simulation target flag (section) 0113 sets a flag indicating a target index, and therefore the output from the simulation target flag (section) 0113 may be a flag indicating “electricity price”. The evaluation value calculation process 0101 calculates an evaluation value indicating the association degree of each index other than the target index with the target index (for example, the correlation coefficient between the price and the demand or the correlation coefficient between the price and the supply) based on the time-series data 0112 of the indices satisfying the evaluation value calculation conditions 0111. The simulation target flag (target index flag) 0113 may indicate a single index, or it may indicate a plurality of indices.

The index selection process 0102 selects an index (a related index) to be used for simulation of the target index from among indices other than the target index based on evaluation values each indicating the association degree of one of the indices other than the target index with the target index (for example, the correlation coefficient between the price and the demand and the correlation coefficient between the price and the supply) and further based on an index selection conditions 0114 indicating a relation(s) which exhibits a high association degree (for example, indicating the correlation (coefficient) between the price and the demand if it is strong). The evaluation values are calculated by the evaluation value calculation process 0101 using the time-series data 0112 of the indices satisfying the evaluation value conditions 0111. In the above process, the index selection process 0102 may select a single index, or it may select a plurality of indices.

After selecting an evaluation value indicating the association degree of an index with the target index based on the index selection conditions 0114, the index selection process 0102 supplies the selected evaluation value to the parameters estimation process 0103. In response, the parameter estimation process 0103 estimates (calculates) the parameters necessary for simulation of the target index by use of a computer based on the related index (for example, using the correlation coefficient between the price and the demand) selected by the index selection process 0102 and the target index (for example, the electricity price).

After the parameter estimation process 0103 estimates the parameters necessary for the simulation of the target index by use of the computer based on the related index (for example, using the correlation coefficient between the price and the demand) selected by the index selection process 0102 and the target index (for example, the electricity price), the simulation process 0104 simulates the value of the target index (for example, the electricity price) in the future starting with the current value of the target index (for example, the electricity price) based on the necessary parameters and a simulation conditions 0115 specifying the period of years from now for which the target index is to be simulated. The simulation process 0104 then outputs the simulation result of the target index (for example, the electricity price) as the simulation results 0121.

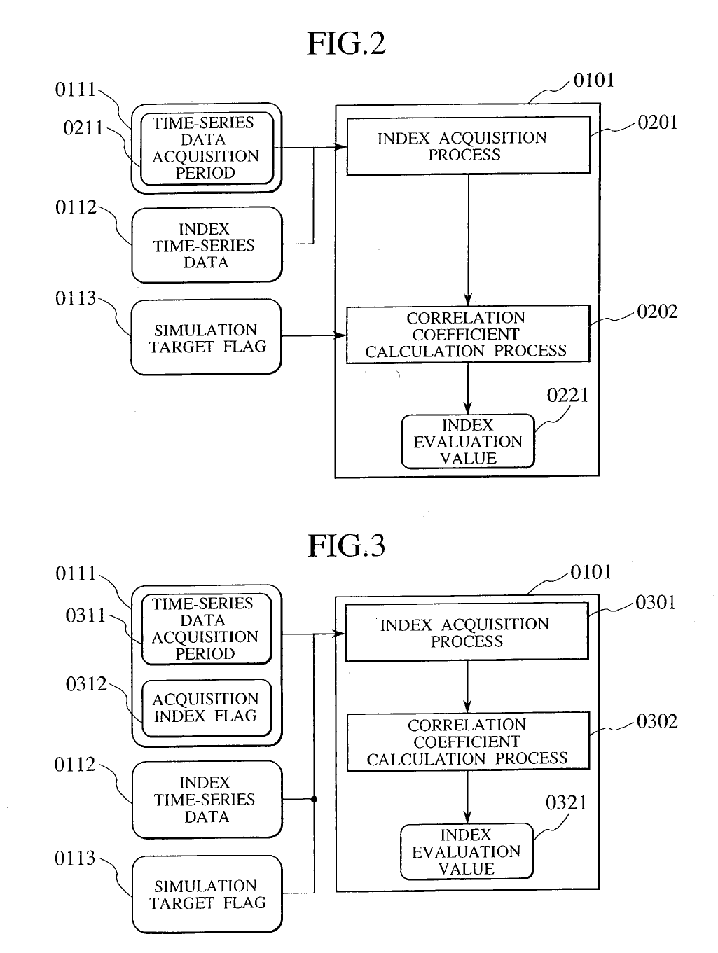

Description will be made below of a first embodiment of the evaluation value calculation process 0101 shown in FIG. 1 with reference to FIG. 2.

Referring to FIG. 2, in the evaluation value calculation process 0101, the index acquisition process 0201 obtains data corresponding to a time-series data acquisition period 0211, which constitutes the evaluation value calculation conditions 0111, from the index time-series data (section) 0112 that stores (data of) indices related to an index to be simulated (a target index) which changes with time (for example, if the simulation target field is the electric power market, examples of the indices are such items as price, demand, and supply). That is, if the time-series data acquisition period 0211 is from Jan. 1, 1990 to Dec. 31, 2000, the index acquisition process 0201 obtains data of all indices stored in the index time-series data (section) 0112 for that target period (of ten years from Jan. 1, 1990 to Dec. 31, 2000) indicated by the time-series data acquisition period 0211.

Based on the data obtained by the index acquisition process 0201, a correlation coefficient calculation process 0202, shown in FIG. 2, calculates the correlation coefficient between the target index indicated by the simulation target flag 0113 (for example, electricity price) and each index other than the target index (for example, the correlation coefficient between the price and the demand or the correlation coefficient between the price and the supply), and stores it as the index evaluation value 0221. It should be noted that correlation coefficient ρᵢⱼ between indices i and j is calculated by use of the following formulas.

$$\begin{matrix}{ρ}_{ij} = \frac{C ( i , j )}{{σ}_{i} {σ}_{j}} \\ & [ Formula 1 ] \\ C ( i , j ) = \frac{1}{N} {\sum }_{n = 1}^{N} ( {x}_{i , n} - {\overline{x}}_{i} ) ( {x}_{j , n} - {\overline{x}}_{j} ) & [ Formula 2 ] \\ {σ}_{i} = \sqrt{\frac{1}{N} {\sum }_{n = 1}^{N} {( {x}_{i , n} - {\overline{x}}_{i} )}^{2}} & [ Formula 3 ] \\ {σ}_{j} = \sqrt{\frac{1}{N} {\sum }_{n = 1}^{N} {( {x}_{j , n} - {\overline{x}}_{j} )}^{2}} \\ & [ Formula 4 ] \\ {\overline{x}}_{i} = \frac{1}{N} {\sum }_{n = 1}^{N} {x}_{i , n} & [ Formula 5 ] \\ {\overline{x}}_{j} = \frac{1}{N} {\sum }_{n = 1}^{N} {x}_{j , n} & [ Formula 6 ]\end{matrix}$$

ρᵢⱼ: correlation coefficient between indices i and j

C(_{i,j}): covariance between indices i and j

σᵢ(σⱼ): standard deviation of index i (j)

N: number of pieces of time-series data of indices

x_{i,n}(x_{j,n}): n-th piece of time-series data of index i (j)

xᵢ(xⱼ): expectation of index i (j)

It should be noted that if the subsequent index selection process 0102 compares the magnitudes of the calculated correlation coefficients using their absolute values, the absolute value of each correlation efficient may be stored as the index evaluation value 0221.

Description will be made below of a second embodiment of the evaluation value calculation process 0101 shown in FIG. 1 with reference to FIG. 3.

The second embodiment shown in FIG. 3 is different from the first embodiment shown in FIG. 2 in that the evaluation value calculation conditions 0111 of the second embodiment include an acquisition index flag (related index flag) 0312 in addition to the time-series data acquisition period 0311. The other portions of the second embodiment are the same as those of the first embodiment shown in FIG. 2. For (a period specified by) the time-series data acquisition period 0311 included in the evaluation value calculation conditions 0111 of the second embodiment shown in FIG. 3, the index acquisition process 0301 obtains data of an index specified by the acquisition index flag 0312 and the simulation target flag 0113 (for example, if the simulation target field is the electric power market, an example of the index is electricity price) from the index time-series data (section) 0112 that stores (data of) indices related to a target index which changes with time (for example, the simulation target field is the electric power market, examples of the indices are such items as price, demand, and supply). That is, if the time-series data acquisition period 0311 is from Jan. 1, 1990 to Dec. 31, 2000, the index acquisition process 0301 obtains data of all of the indices which are stored in the index time-series data (section) 0112 and indicated by the acquisition index flag 0312 and the simulation target flag 0113, for that target period (of 10 years from Jan. 1, 1990 to Dec. 31, 2000).

Based on the data obtained by the index acquisition process 0301, a correlation coefficient calculation process 0302, shown in FIG. 3, calculates the correlation coefficient between the target index indicated by the simulation target flag 0113 (for example, electricity price) and each index other than the target index (for example, the correlation coefficient between the price and the demand or the correlation coefficient between the price and the supply), and stores it as the index evaluation value 0321.

It should be noted that correlation coefficient ρᵢⱼ between indices i and j is calculated by use of formulas 1 to 6 described above. It should be further noted that the correlation coefficient calculation process 0302 shown in FIG. 3 calculates the correlation coefficient between the target index and each index other than the target index (for example, the correlation coefficient between the price and the demand or the correlation coefficient between the price and the supply) using the same steps as those employed by the correlation coefficient calculation process 0202 shown in FIG. 2. Furthermore, the index evaluation value 0321 has the same structure as that of the index evaluation value 0221 shown in FIG. 2. Therefore, as is the case with the index evaluation value 0221 shown in FIG. 2, if the subsequent index selection process 0102 compares the magnitudes of the calculated correlation coefficients using their absolute values, the absolute value of each correlation coefficient may be stored as the index evaluation value 0321.

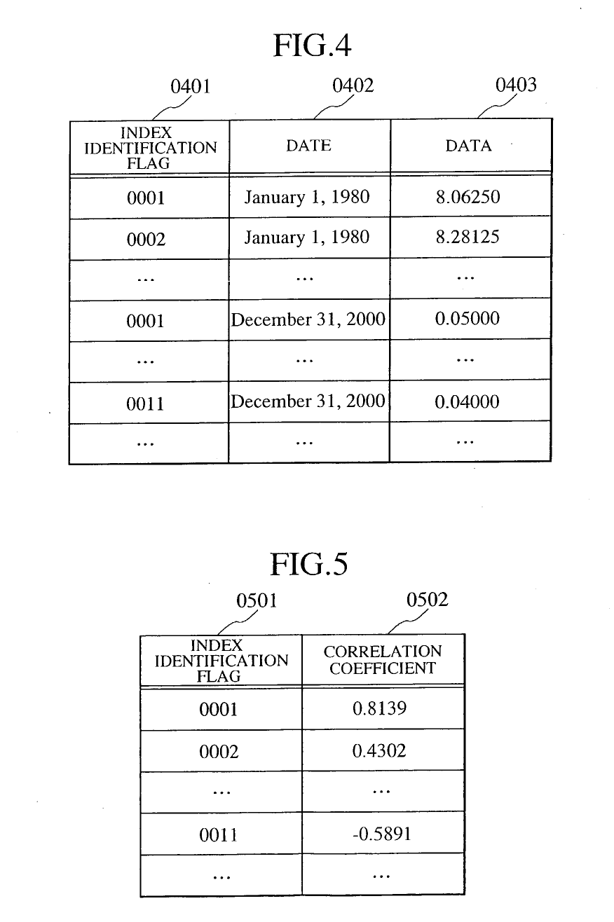

Description will be made below of an embodiment of the index time-series data 0112 shown in FIGS. 1 to 3 with reference to FIG. 4.

Referring to FIG. 4, the index time-series data 0112 shown in FIGS. 1 to 3 is made up of: an index identification flag 0401 for specifying an index related to a target index (for example, if the simulation target field is the electric power market, examples of the related index are such items as price, demand, and supply); a date 0402 for indicating the date at which (data of) the index specified by the index identification flag 0401 was stored (for example, if the simulation target field is the electric power market, examples of the index are such items as price, demand, and supply); and data 0403 for indicating a data value of the index (for example, interest rate). The form of the index time-series data 0112 is not limited to that shown in FIG. 4. Any form which includes at least the index identification flag 0401, the date 0402, and the data 0403 can be used. It goes without saying that the index time-series data 0112 may includes data other than the identification flag 0401, the date 0402, and the data 0403.

The index acquisition process 0201 shown in FIG. 2 checks the time-series data acquisition period 0211 (for the evaluation value calculation process 0101) and the date 0402 of the index time-series data 0112 shown in FIG. 4 to obtain information on the target period. The index acquisition process 0301 shown in FIG. 3, on the other hand, checks the time-series data acquisition period 0311 (for the evaluation value calculation process 0101), the date 0402 of the index time-series data 0112 shown in FIG. 4, the acquisition index flag 312 and the simulation target flag 0113 (for the evaluation value calculation process 0101), and the index identification flag 0401 of the index time-series data 0112 shown in FIG. 4 to obtain information on the indices for the target period.

It should be noted that the correlation coefficient calculation process 0202 shown in FIG. 2 compares the simulation target flag 0113 against the index identification flag 0401 of the index time-series data 0112 shown in FIG. 4 and recognizes the index whose index identification flag coincides with the simulation target flag 0113 as the target index (for example, electricity price). Further, the index time-series data obtained from formulas 1 to 6 corresponds to the data 0403 of the index time-series data 0112 shown in FIG. 4.

Description will be made below of a first embodiment of the index evaluation value 0221 shown in FIG. 2 or the index evaluation value 0321 shown in FIG. 3 with reference to FIG. 5.

Referring to FIG. 5, the first embodiment of the index evaluation value 0221 shown in FIG. 2 or the index evaluation value 0321 shown in FIG. 3 is used when only a single target index is employed (for example, electricity price) and made up of: an index identification flag 0501 for identifying an index; and an evaluation value 0502. The index identification flag 0501 is used to identify each index other than the target index (for example, if the simulation target field is the electric power market, examples of the index are such items as demand and supply). Further, the evaluation value 0502 shown in FIG. 5 holds a correlation coefficient calculated by the correlation coefficient calculation process 0202 shown in FIG. 2 or the correlation coefficient calculation process 0302 shown in FIG. 3. The first row of the first embodiment shown in FIG. 5 indicates that the correlation coefficient between the index indicated by the index identification flag value “0001” and the target index is 0.8139. It should be noted that the form of the first embodiment of the index evaluation value 0221 shown in FIG. 2 or the index evaluation value 0321 shown in FIG. 3, which is used when a single target index is employed (for example, electricity price only), is not limited to that shown in FIG. 5. It goes without saying that the index evaluation value 0221 shown in FIG. 2 and the index evaluation value 0321 may each include data other than the index identification flag 0501 and the evaluation value 0502 shown in FIG. 5.

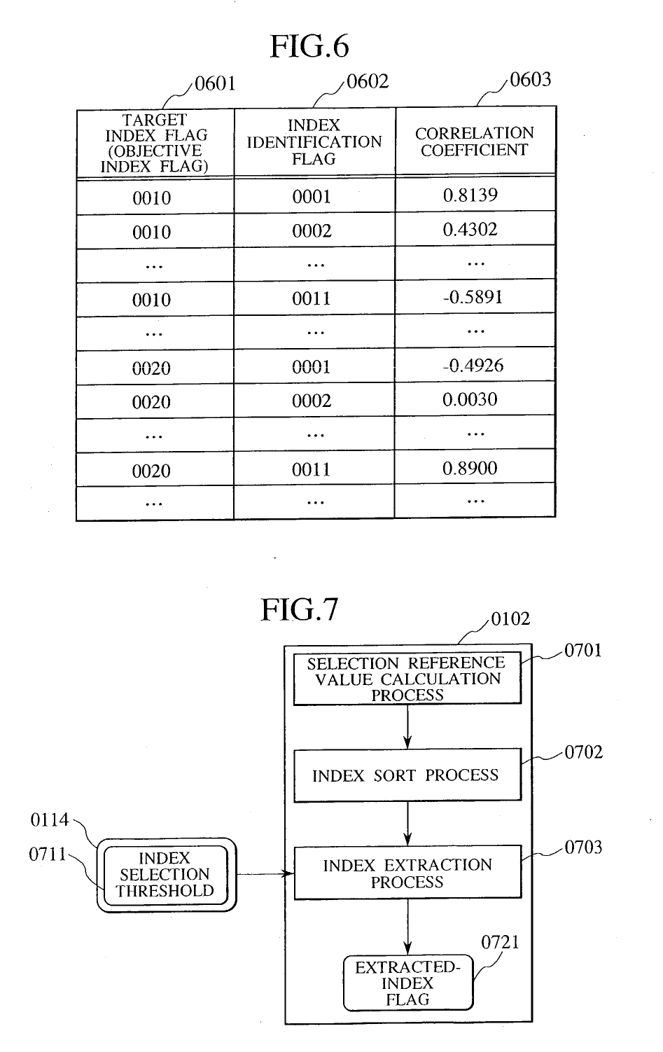

Description will be made below of a second embodiment of the index evaluation value 0221 shown in FIG. 2 or the index evaluation value 0321 shown in FIG. 3 with reference to FIG. 6.

Referring to FIG. 6, the second embodiment of the index evaluation value 0221 shown in FIG. 2 or the index evaluation value 0321 shown in FIG. 3 is used when a plurality of target indices are employed (for example, electricity price, demand, etc.) and made up of: a target index flag 0601 for identifying a target index (for example, electricity, demand, etc.); an index identification flag 0602 for identifying an index (for example, if the simulation target field is the electric power market, an example of the index is “supply”); and an evaluation value 0603. The target index flag 0601 shown in FIG. 6 is used to indicate which one of a plurality of target indices is related to the evaluation value 0603 shown in FIG. 6. The index identification flag 0602 shown in FIG. 6 is used to identify each index other than the target index (for example, if the simulation target field is the electric power market, an example of the index is “supply”), and is the same as the index identification flag 0501 shown in FIG. 5.

Further, the evaluation value 0603 shown in FIG. 6 holds a correlation coefficient (for example, the correlation coefficient between the price and the demand or the correlation coefficient between the price and the supply) calculated by the correlation coefficient calculation process 0202 shown in FIG. 2 or the correlation coefficient calculation process 0302 shown in FIG. 3, and is the same as the evaluation value 0502 shown in FIG. 5.

The first row of the second embodiment shown in FIG. 6 indicates that the correlation coefficient between the target index indicated by the target index flag value “0010” and the index indicated by the index identification flag value “0001” is 0.8139. It should be noted that the form of the second embodiment of the index evaluation value 0221 shown in FIG. 2 or the index evaluation value 0321 shown in FIG. 3, which is used when a plurality of target indices are employed, is not limited to that shown in FIG. 6. The index evaluation value 0221 shown in FIG. 2 and the index evaluation value 0321 shown in FIG. 3 may each include data other than the target index flag 0601, the index identification flag 0602, and evaluation value 0603.

Description will be made below of a first embodiment of the index selection process 0102 shown in FIG. 1 with reference to FIG. 7.

Referring to FIG. 7, the index selection conditions (section) 0114 shown in FIG. 7 supplies a condition for selecting an index to the index selection process 0102 shown in FIG. 7 (for example, the correlation coefficient between the price and the demand is high, this correlation coefficient is selected). The index selection conditions 0114 is made up of an index selection threshold 0711. The selection reference value calculation process 0701 shown in FIG. 7 calculates an index selection reference value based on the index evaluation value 0221, shown in FIG. 2, or the index evaluation value 0321, shown in FIG. 3, calculated by the evaluation value calculation process 0101 shown in FIG. 1 with respect to a target indices (for example, electricity price). For example, when the evaluation values are correlation coefficients, the absolute values of correlation coefficients with respect to target indices (for example, electricity price) are added together (examples of the correlation coefficients are the correlation coefficient between the price and the demand and the correlation coefficient between the price and the supply) by use of formula 7 below, and the result is set as a selection reference value.

$${e}_{i} = {\sum }_{m = 1}^{M} \vert {ρ}_{m i} \vert \qquad [ Formula 7 ]$$

eᵢ: selection reference value of index i

M: number of target indices

ρₘᵢ: correlation coefficient between target index m and index i

In formula 7, if the number of target indices is 1 (for example, the target index “electricity price” only), the selection reference value of an index is the same as the absolute value of the correlation coefficient of the index with the target index (for example, if the target index is “electricity price” , examples of the correlation coefficient of the index are the correlation coefficient between the price and the demand and the correlation coefficient between the price and the supply). The index sort process 0702 in the index selection process 0102 shown in FIG. 7 sorts indices based on the selection reference value of each index calculated by the selection reference value calculation process 0701 in the index selection process 0102 shown in FIG. 7. The index extraction process 0703 in the index selection process 0102 shown in FIG. 7 extracts related indices from the indices sorted by the index sort process 0702 in the index selection process 0102 shown in FIG. 7 based on the index selection threshold 0711 (for the index selection process 0102) shown in FIG. 7. (The flags of) the related indices extracted by the index extraction process 0703 in the index selection process 0102 shown in FIG. 7 are stored as extracted-related-index flags 0721.

At that time, if the index selection threshold 0711 of the index selection conditions 0114 shown in FIG. 7 is set for selection reference values, the index extraction process 0703 in the index selection process 0102 shown in FIG. 7 selects indices whose selection reference value is larger than (or not less than) the index selection threshold 0711 of the index selection conditions 0114 shown in FIG. 7 as related indices. If the index selection threshold 0711 is set for the number of related indices to be extracted, a number of indices indicated by the index selection threshold 0711 are extracted as related indices in the order of decreasing selection reference value.

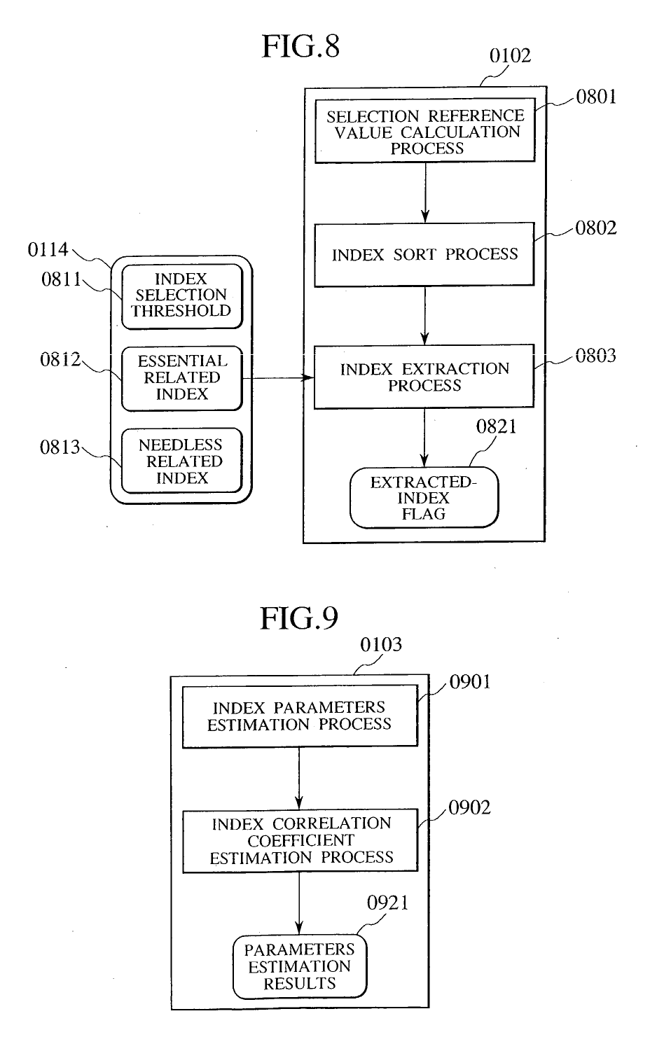

Description will be made below of a second embodiment of the index selection process 0102 shown in FIG. 1 with reference to FIG. 8.

Referring to FIG. 8, the second embodiment shown in FIG. 8 is different from the first embodiment shown in FIG. 7 in that whereas the index selection conditions 0114 (for the index selection process 0102) shown in FIG. 7 is made up of only the index selection threshold 0711, the index selection conditions 0114 (for the index selection process 0102) shown in FIG. 8 is made up of an essential related index 0812 and a needless related index 0813 in addition to the index selection threshold 0811.

Referring to FIG. 8, the selection reference value calculation process 0801 and the index sort process 0802 in the index selection process 0102 perform the same processing as that performed by the selection reference value calculation process 0701 and the index sort process 0702 in the index selection process 0102 shown in FIG. 7, respectively. Further, the index extraction process 0803 in the index selection process 0102 shown in FIG. 8 performs extraction processing similar to that performed by the index extraction process 0703 in the index selection process 0102 shown in FIG. 7. However, the index extraction process 0803 makes sure that each index indicated by the essential related index 0812 of the index selection conditions 0114 shown in FIG. 8 be selected and, furthermore, each index indicated by the needless related index 0813 of the index selection conditions 0114 shown 8 be deselected. The flags of the indices extracted by the index extraction process 0803 in the index selection process 0102 shown in FIG. 8 are stored as related index flags 0821.

Description will be made below of a first embodiment of the parameters estimation process 0103 shown in FIG. 1 with reference to FIG. 9.

Referring to FIG. 9, based on the related indices selected by the index selection process 0102 shown in FIG. 1 (for example, using the correlation coefficient between the price and the demand) and the target index (for example, electricity price), the parameters estimation process 0103 estimates or calculates the values of the parameters necessary for simulating the target index by use of a computer. The parameters estimation process 0103 is made up of an index parameters estimation process 0901 and an index correlation coefficient estimation process 0902.

Let K denote the sum of the number of the target indices and that of the related indices. Furthermore, assume that there are N pieces of time-series data for each of K indices. Further assume that these pieces of time-series data meet the time-series data acquisition period 0211 of the evaluation value calculation conditions 0111 shown in FIG. 2 (or the time-series data acquisition period 0311 of the evaluation value calculation conditions 0111 shown in FIG. 3), and are selected from the index time-series data 0112 shown in FIG. 1 by the evaluation value calculation process 0101 shown in FIG. 1. The K number of indices are each assumed to meet the following difference equation (formula 8).

Δx_{i,n}=x_{i,n+1}−x_{i,n}=aᵢ+b_{i,1}x_{1,n}+b_{i,2}x_{2,n}+ . . . +b_{i,K}x_{K,n}+σᵢx_{i,n}ε_{i,n} [Formula 8]

Δx_{i,n}: difference between the n-th piece of time-series data and the (n+1)-th piece of time-series data of index i

x_{i,n}: n-th piece of time-series data of index i

aᵢ, b_{i,k} σᵢ: parameters

εᵢₙ: n-th piece of data of random change of index i

It should be noted that formula 9 below is obtained by expressing formula 8 with matrices.

$$[ \begin{matrix}Δ {x}_{1 , n} \\ Δ {x}_{2 , n} \\ ⋯ \\ Δ {x}_{K , n}\end{matrix} ] = [ \begin{matrix}{x}_{1 , n + 1} - {x}_{1 , n} \\ {x}_{2 , n + 1} - {x}_{2 , n} \\ ⋯ \\ {x}_{K , n + 1} - {x}_{K , n}\end{matrix} ] = [ \begin{matrix}{a}_{1} \\ {a}_{2} \\ … \\ {a}_{k}\end{matrix} ] + [ \begin{matrix}{b}_{1 , 1} & {b}_{1 , 2} & ⋯ & {b}_{1 , K} \\ {b}_{2 , 1} & {b}_{2 , 2} & ⋯ & {b}_{2 , K} \\ ⋮ & ⋮ & ⋰ & ⋮ \\ {b}_{K , 1} & {b}_{K , 2} & ⋯ & {b}_{K , K}\end{matrix} ] [ \begin{matrix}{x}_{1 , n} \\ {x}_{2 , n} \\ ⋯ \\ {x}_{K , n}\end{matrix} ] [ \begin{matrix}{σ}_{1} {x}_{1 , n} {ϵ}_{1 , n} \\ {σ}_{2} {x}_{2 , n} {ϵ}_{2 , n} \\ ⋯ \\ {σ}_{K} {x}_{K , n} {ϵ}_{K , n}\end{matrix} ] \qquad [ Formula 9 ]$$

Further, formula 10 below is obtained by solving formula 8 for the random change ε_{i,n}.

$${ϵ}_{i , n} = \frac{\begin{matrix}{x}_{i , n + 1} - {x}_{i , n} - \\ ( {a}_{i} + {b}_{i , 1} {x}_{1 , n} + {b}_{i , 2} {x}_{2 , n} + … + {b}_{i , K} {x}_{N , n} )\end{matrix}}{{σ}_{i} {x}_{i , n}} \qquad [ Formula 10 ]$$

The index parameters estimation process 0901 in the parameters estimation process 0103 shown in FIG. 9 determines the values of the parameters aᵢ, b_{i,k}, and σᵢ with which the random changes {ε_{i,n}} (where n is 1, 2, . . . , and N) derived from the index time-series data {x_{i,n}} (where n is 1, 2, . . . , and N) in formula 10 are closest to moments of the standard normal distribution (its first and second moments are 0 and 1, respectively). This estimation method is referred to as the generalized moment method and described, in detail, in a book entitled “Term Structure Model And Interest Rate Derivatives” authored by Masaaki Kijima and published by Asakura-Shoten in 1999, providing a well-known example. It should be noted that the equation which each parameter is assumed to satisfy is not limited to formula 8. Another equation can certainly be used. Furthermore, it may be arranged such that a plurality of candidate equations are prepared beforehand and upon being informed of which one of them is selected to be used, the index parameters estimation process 0901 determines the values of the parameters based on the selection result.

After the index parameters estimation process 0901 in the parameters estimation process 0103 shown in FIG. 9 determines the values of the parameters aᵢ, b_{i,k}, and σᵢ with which the random changes{ε_{i,n}} (where n is 1, 2, . . . , and N) are closest to moments of the standard normal distribution for every i (i is 1, 2, . . . , and K), the index correlation coefficient estimation process 902 in the parameters estimation process 0103 shown in FIG. 9 calculates the correlation coefficient between the random changes {ε_{i,n}} and {ε_{k,n}} of indices i and k, respectively, by use of the following formulas.

$$\begin{matrix}{ρ}_{ϵ , ik} = \frac{{C}_{ϵ} ( i , k )}{{σ}_{ϵ , i} {σ}_{ϵ , j}} & [ Formula 11 ] \\ {C}_{ϵ} ( i , k ) = \frac{1}{N} {\sum }_{n = 1}^{N} ( {ϵ}_{i , n} - {\overline{ϵ}}_{i} ) ( {ϵ}_{k , n} - {\overline{ϵ}}_{k} ) & [ Formula 12 ] \\ {σ}_{ϵ , i} = \sqrt{\frac{1}{N} {\sum }_{n = 1}^{N} {( {ϵ}_{i , n} - {\overline{ϵ}}_{i} )}^{2}} & [ Formula 13 ] \\ {σ}_{ϵ , k} = \sqrt{\frac{1}{N} {\sum }_{n = 1}^{N} {( {ϵ}_{k , n} - {\overline{ϵ}}_{k} )}^{2}} & [ Formula 14 ] \\ {\overline{ϵ}}_{i} = \frac{1}{N} {\sum }_{n = 1}^{N} {ϵ}_{i , n} & [ Formula 15 ] \\ {\overline{ϵ}}_{k} = \frac{1}{N} {\sum }_{n = 1}^{N} {ϵ}_{k , n} & [ Formula 16 ]\end{matrix}$$

ρ_{ε,ik}: correlation coefficient between {ε_{i,n}} and {ε_{k,n}}

C_{ε}(i,k): covariance between {ε_{i,n}} and {ε_{k,n}}

σ_{ε,i}(σ_{ε,k}): standard deviation of {ε_{i,n}} ({ε_{k,n}})

εᵢ(εₖ): expectation of {ε_{i,n}} ({ε_{k,n}})

The parameters aᵢ, b_{i,k}, σᵢ, and ρ_{ε,ik} (i and k are each 1, 2, . . . , and K) calculated as described above are stored as parameters estimation results 0921.

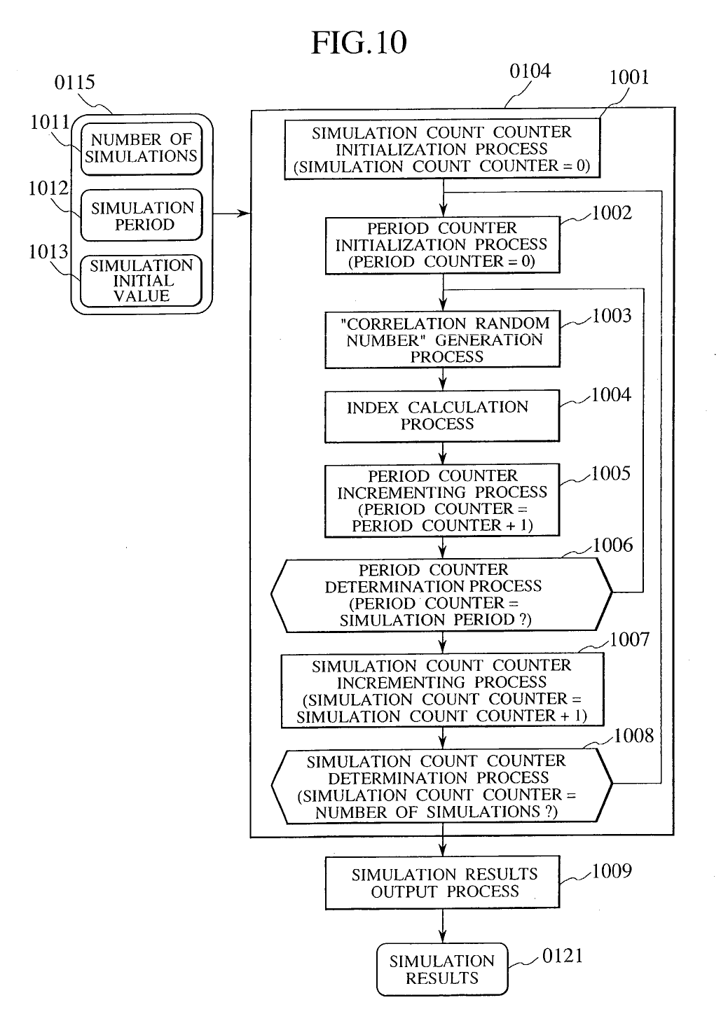

Description will be made below of a first embodiment of the simulation process 0104 shown in FIG. 1 with reference to FIG. 10.

Referring to FIG. 10, the simulation process 0104 simulates (the value of) a target index (for example, electricity price) in the future starting with the current (value of the) target index (for example, electricity price) based on the necessary parameters and the simulation conditions 0115 specifying the period of years from now for which the target index is to be simulated. Specifically, the simulation process 0104 simulates the “time-series change” in the value of the index by use of formula 8 (difference equation). At that time, the simulation process 0104 sets the simulation initial value x_{i,0} (i is 1, 2, . . . , and K) of each index and the simulation period T and generates a pseudorandom number to determine the value of the random change {ε_{i,n}} (i is 1, 2, . . . , and K, and n is 0, 1, 2, . . . , and T−1) of each index. The simulation process 0104 calculates the value {x_{i,n}} (i is 1, 2, . . . , and K, and n is 0, 1, 2, . . . , and T) of each index based on the parameters aᵢ, b_{i,k}, σᵢ, and ρ_{ε,ik} (i and k are each 1, 2, . . . , and K) calculated by the parameters estimation process 0103. This simulation is performed a predetermined number of times.

The example shown in FIG. 10 receives the “number of simulations” 1011, a simulation period 1012, and a simulation initial value 1013 as the simulation conditions 0115.

The simulation count counter initialization process 1001 in the simulation process 0104 shown in FIG. 10 initializes the simulation count counter for counting the simulation count such that it is set to 0. The period counter initialization process 1002, on the other hand, initializes the period counter for counting the period count such that it is set to 0.

The “correlation random number” generation process 1003 in the simulation process 0104 shown in FIG. 10 calculates the random change {ε_{i,n}} of each index for the n-th period (indicated by the period counter) based on the correlation coefficients between the random changes of the indices ρ_{ε,ik} (i and k are each 1, 2, . . . , and K) calculated by the parameters estimation process 0103 shown in FIG. 1. In this calculation, P denotes a correlation coefficient matrix whose elements are correlation coefficients.

$$P = [ \begin{matrix}{ρ}_{ϵ , 11} & {ρ}_{ϵ , 12} & ⋯ & {ρ}_{ϵ , 1 K} \\ {ρ}_{ϵ , 21} & {ρ}_{ϵ , 22} & ⋯ & {ρ}_{ϵ , 2 K} \\ ⋮ & ⋮ & ⋰ & ⋮ \\ {ρ}_{ϵ , K1} & {ρ}_{ϵ , K2} & ⋯ & {ρ}_{ϵ , KK}\end{matrix} ] \qquad [ Formula 17 ]$$

The correlation coefficient matrix P (formula 17) is decomposed by the Cholesky factorization (decomposition) using the following procedure. As a result, a lower triangular matrix P′ which is a Cholesky decomposition matrix of P is obtained. It should be noted that the Cholesky decomposition is described, in detail, on page 116 of the book “Introduction To Financial Engineering I” authored by Masaaki Kijima and published by JUSE Press, Ltd. in 1994, providing a well-known example.

ρ′_{ε,11}=\sqrt{ρ_{ε,11}} [Formula 18]

ρ′_{ε,i1}=ρ_{ε,i1} (i=2, 3, . . . , K) [Formula 19]

$$\begin{matrix}{ρ}_{ϵ , jj}^{′} = \sqrt{{ρ}_{ϵ , jj} - {\sum }_{k = 1}^{j - 1} {( {ρ}_{ϵ , j k}^{′} )}^{2}} ( j = 2 , 3 , … , K ) & [ Formula 20 ] \\ {ρ}_{ϵ , jj}^{′} = \frac{1}{{ρ}_{ϵ , jj}^{′}} ( {ρ}_{ϵ , ij} - {\sum }_{k = 1}^{j - 1} {ρ}_{ϵ , ik}^{′} {ρ}_{ϵ , jk}^{′} ) ( j < i , i = 2 , 3 , … , K - 1 ) & [ Formula 21 ] \\ {P}^{′} = [ \begin{matrix}{ρ}_{ϵ , 11}^{′} & 0 & ⋯ & 0 \\ {ρ}_{ϵ , 21}^{′} & {ρ}_{ϵ , 22}^{′} & ⋰ & ⋮ \\ ⋮ & ⋮ & ⋰ & 0 \\ {ρ}_{ϵ , K1}^{′} & {ρ}_{ϵ , K2}^{′} & ⋯ & {ρ}_{ϵ , KK}^{′}\end{matrix} ] & [ Formula 22 ]\end{matrix}$$

Then, K′ number of pseudorandom numbers uᵢ (i is 1, 2, . . . , and K) equal to the number of the indices are generated. The pseudorandom numbers uᵢ generated on a computer are each assumed to follow a uniform distribution [0, 1]. These pseudorandom numbers uᵢ are then converted to random numbers eᵢ which follow the standard normal distribution by use of the following formula.

eᵢ=Φ⁻¹(uᵢ) [Formula 23]

Φ⁻¹: inverse function of standard normal distribution

At that time, since Φ⁻¹ is difficult to analytically calculate, the following Moro approximation is used. The Moro approximation is described, in detail, on pages 133 to 135 of the book “Introduction To Financial Engineering III” authored by Masaaki Kijima, Izumi Nagayama, and Yoshiyuki Ohmi and published by JUSE Press, Ltd. in 1996, providing a well-known example. Therefore, its detailed explanation will be omitted.

P′ calculated by use of formula 22 is multiplied by the vector {eᵢ} whose element is eᵢ calculated by use of formula 23 to produce the random changes {ε_{i,n}}, as in the following formula.

$$[ \begin{matrix}{ϵ}_{1 , n} \\ {ϵ}_{2 , n} \\ ⋮ \\ {ϵ}_{K , n}\end{matrix} ] = [ \begin{matrix}{ρ}_{ϵ , 11}^{′} & 0 & ⋯ & 0 \\ {ρ}_{ϵ , 21}^{′} & {ρ}_{ϵ , 22}^{′} & ⋰ & ⋮ \\ ⋮ & ⋮ & ⋰ & 0 \\ {ρ}_{ϵ , K1}^{′} & {ρ}_{ϵ , K2}^{′} & ⋯ & {ρ}_{ϵ , KK}^{′}\end{matrix} ] [ \begin{matrix}{ϵ}_{1} \\ {ϵ}_{2} \\ ⋮ \\ {ϵ}_{K}\end{matrix} ] \qquad [ Formula 24 ]$$

The index calculation process 1004 in the simulation process 0104 shown in FIG. 10 calculates the next index value x_{i,n+1} (i is 1, 2, . . . , and K) by use of formula 8 based on the previously obtained index value {x_{i,n}} (i is 1, 2, . . . , and K), the parameters ρ_{ε,ik} (i and k are each 1, 2, . . . , and K) calculated by the parameters estimation process 0103 shown in FIG. 1, and ε_{i,n} (i is 1, 2, . . . , and K) obtained by the “correlation random number” generation process 1003 in the simulation process 0104 shown in FIG. 10.

The period counter incrementing process 1005 in the simulation process 0104 shown in FIG. 10 increments the period counter from n to n+1. Then, the period counter determination process 1006 in the simulation process 0104 shown in FIG. 10 determines whether the current value of the period counter corresponds to the simulation period 1012 of the simulation conditions 0115, and if it does, then the processing proceeds to the simulation count counter incrementing process 1007 in the simulation process 0104 shown in FIG. 10, assuming that the current simulation has ended. If the current value of the period counter does not correspond to the simulation period 1012 of the simulation conditions 0115, on the other hand, the processing returns to the “correlation random number” generation process 1003 shown in FIG. 10 in order to perform simulation for the next period. The simulation count counter incrementing process 1007 in the simulation process 0104 shown in FIG. 10 increments the simulation count counter from nn to nn+1.

The simulation count counter determination process 1008 in the simulation process 0104 shown in FIG. 10 determines whether the current value of the simulation count counter coincides with the “number of simulations” 1011 specified by the simulation conditions 0115, and if it does, then the processing proceeds to the simulation results output process 1009 in the simulation process 0104 shown in FIG. 10, assuming that all simulations have ended. If the current value of the simulation count counter does not coincide with the “number of simulations” 1011 specified by the simulation conditions 0115, on the other hand, the processing returns to the period counter initialization process 1002 in the simulation process 0104 shown in FIG. 10 in order to perform the next simulation. The simulation results output process 1009 in the simulation process 0104 shown in FIG. 10 stores the simulation results of the target index as the simulation results 0121. It should be noted that it is not necessary to wait until all simulations have been completed to output the simulation results. The simulation results may be output each time one or a plurality of simulations have been completed.

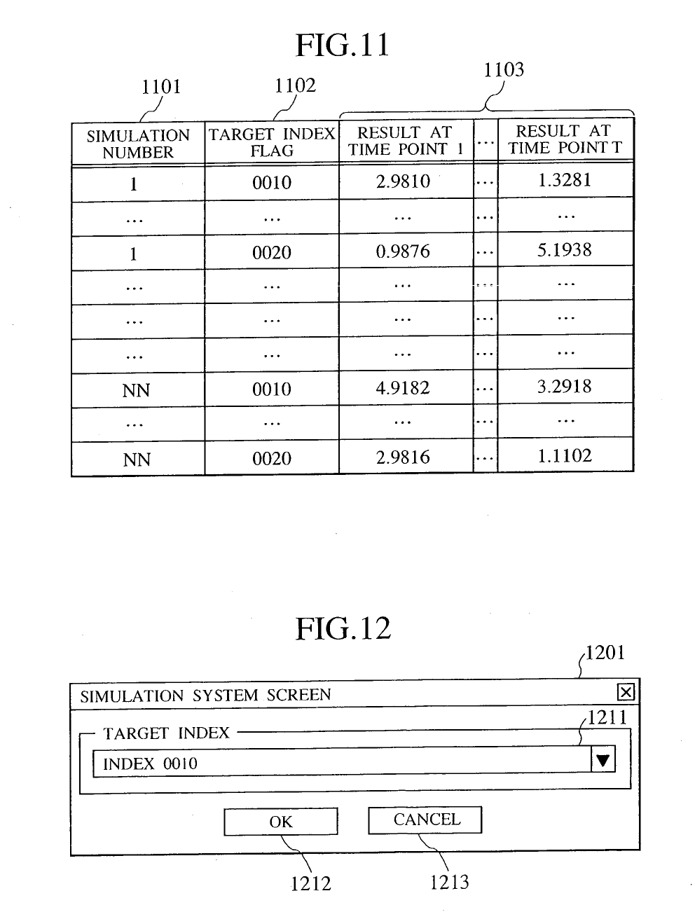

Description will be made below of an embodiment of the simulation results 0121 shown in FIG. 1 with reference to FIG. 11.

Referring to FIG. 11, the simulation results 0121 shown in FIG. 1 comprises the following fields: a simulation number 1101 for indicating the simulation number of simulation results; a target index flag 1102 for identifying a target index; and a data storage 1103 for storing simulation results of a target index at each time point (for each period) in a simulation. The first row of the simulation results 0121 shown in FIG. 11 indicates that the simulation result of the target index indicated by the target index flag value “0010” at the time point 1 in the first simulation is 2.9810 and that at the time point T is 1.3281. It should be noted that if only a single target index is employed, such fields as the simulation number 1101 and the target index flag 1102 for identifying a target index are not necessarily required. Further, the form of the simulation results is not limited to that shown in FIG. 11. The simulation results may include data other than the simulation number 1101, the target index flag 1102, and the data storage 1103.

Description will be made below of a first embodiment of a simulation system using the simulation method shown in FIG. 1 with reference to FIG. 12.

The first embodiment shown in FIG. 12 employs only a single target index (for example, electricity price). First of all, when the simulation system shown in FIG. 1 is started up, the simulation system screen 1201 shown in FIG. 12 is displayed on a computer display (not shown). The simulation system screen 1201 displayed on the display is provided with a target index selection pull-down menu 1211, an OK button 1212, and a cancel button 1213, as shown in FIG. 12. The target index selection pull-down menu 1211 on the simulation system screen 1201 shown in FIG. 12 makes it possible to select a target index (candidate) from candidate indices.

Further, when the OK button 1212 on the simulation system screen 1201 shown in FIG. 12 is selected (clicked with the cursor), the flag of the index selected in the target index selection pull-down menu 1211 on the simulation system screen 1201 shown in FIG. 12 is stored as the simulation target flag 0113 shown in FIG. 1, and the processes shown in FIG. 1 from the evaluation value calculation process 0101 to the simulation process 0104 are sequentially activated.

When the cancel button 1213 on the simulation system screen 1201 shown in FIG. 12 is selected, on the other hand, the simulation system shown in FIG. 1 is shut down. It should be noted that elements to be provided on the simulation system screen 1201 shown in FIG. 12 are not limited to the target index selection pull-down menu 1211, the OK button 1212, and the cancel button 1213. The simulation system screen 1201 may be provided with other elements.

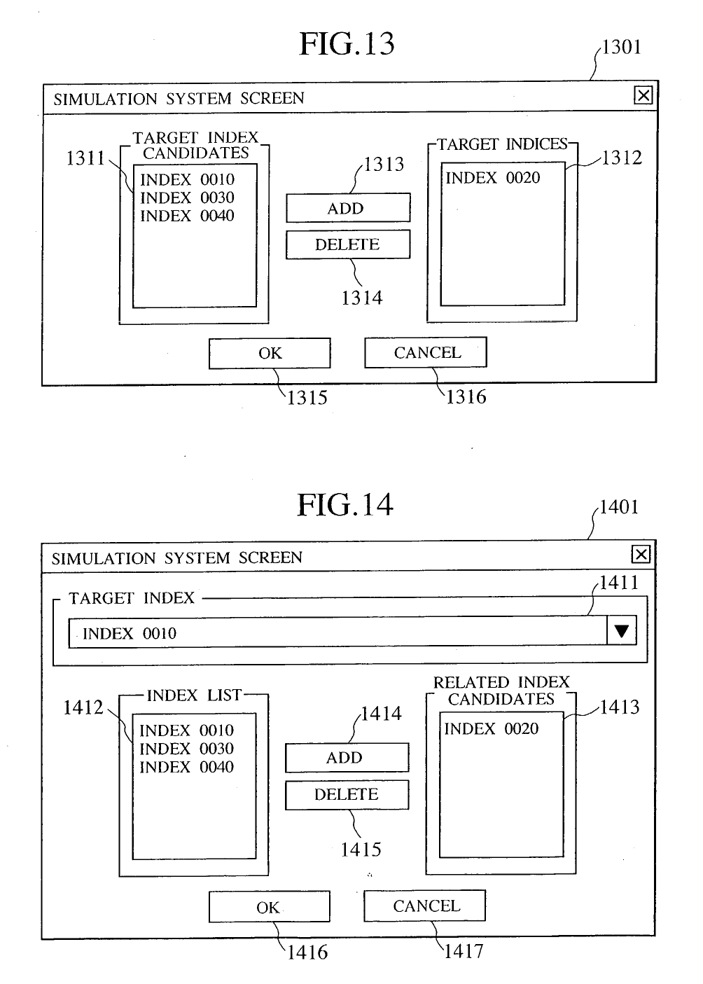

Description will be made below of a second embodiment of the simulation system using the simulation method shown in FIG. 1 with reference to FIG. 13.

The second embodiment shown in FIG. 13 employs a plurality of target indices. First of all, when the simulation system shown in FIG. 1 is started up, the simulation system screen 1301 shown in FIG. 13 is displayed on a computer display (not shown). The simulation system screen 1301 displayed on the display is provided with a target index candidate list box 1311, a target index list box 1312, an add button 1313, a delete button 1314, an OK button 1315, and a cancel button 1316, as shown in FIG. 13.

When the add button 1313 shown in FIG. 13 is selected (clicked with the cursor) after an index (for example, index 0020) is selected from among the plurality of indices (indices 0010 to 0040) indicated in the target index candidate list box 1311 shown in FIG. 13, the index (for example, index 0020) selected from the target index candidate list box 1311 on the simulation system screen 1301 shown in FIG. 13 is removed from the indices indicated in the target index candidate list box 1311 as a deleted index, and added to the indices indicated in the target index list box 1312 on the simulation system screen 1301 shown in FIG. 13 as an added index.

On the other hand, when the delete button 1314 is selected (clicked with the cursor) after an index (for example, index 0030) indicated in the target index list box 1312 on the simulation system screen 1301 shown in FIG. 13 is selected (clicked with the cursor), the index (for example, index 0030) selected from the target index list box 1312 on the simulation system screen 1301 shown in FIG. 13 is removed from the indices indicated in the target index list box 1312 as a deleted index (in FIG. 13, the index 0030 has already been removed), and added to the indices indicated in the target index candidate list box 1311 as a cancel index.

Further, when the OK button 1315 shown in FIG. 13 is selected (clicked with the cursor), the flags of the indices indicated in the target index list box 1312 shown in FIG. 13 are stored as the simulation target flags 0113 shown in FIG. 1, and the processes shown in FIG. 1 from the evaluation value calculation process 0101 to the simulation process 0104 are sequentially activated. When the cancel button 1316 shown in FIG. 13 is selected, on the other hand, the simulation system shown in FIG. 1 is shut down. It should be noted that the simulation system screen 1301 may be provided with elements other than the target index candidate list box 1311, the target index list box 1312, the add button 1313, the delete button 1314, the OK button 1315, and the cancel button 1316.

Description will be made below of a third embodiment of the simulation system using the simulation method shown in FIG. 1 with reference to FIG. 14.

The third embodiment shown in FIG. 14 narrows down related index candidates. Furthermore, the third embodiment employs only a single target index (for example, electricity price). First of all, when the simulation system shown in FIG. 1 is started up, the simulation system screen 1401 shown in FIG. 14 is displayed on a computer display (not shown). The simulation system screen 1401 displayed on the display is provided with a target index selection pull-down menu 1411, an index list box 1412, a related index candidate list box 1413, an add button 1414, a delete button 1415, an OK button 1416, and a cancel button 1417.

The target index selection pull-down menu 1411 shown in FIG. 14 makes it possible to select a target index (candidate) from candidate indices.

When the add button 1414 shown in FIG. 14 is selected (clicked with the cursor) after an index (for example, index 0020) is selected from among the plurality of indices (indices 0010 to 0040) indicated in the index list box 1412 shown in FIG. 14, the index (for example, index 0020) selected from the index list box 1412 on the simulation system screen 1401 shown in FIG. 14 is removed from the indices indicated in the index list box 1412 as a deleted index, and added to the indices indicated in the related index candidate list box 1413 on the simulation system screen 1401 shown in FIG. 14 as an added index.

On the other hand, when the delete button 1415 is selected (clicked with the cursor) after an index (for example, index 0030) indicated in the related index candidate list box 1413 on the simulation system screen 1401 shown in FIG. 14 is selected (clicked with the cursor), the index (for example, index 0030) selected from the related index candidate list box 1413 on the simulation system screen 1401 shown in FIG. 14 is removed from indices indicated in the related index candidate list box 1413 as a deleted index (in FIG. 14, the index 0030 has already been removed), and added to the index list box 1412 as a cancel index again.

Further, when the OK button 1416 on the simulation system screen 1401 shown in FIG. 14 is selected (clicked with the cursor), the flag of the index selected in target index selection pull-down menu 1411 on the simulation system screen 1401 shown in FIG. 14 and the flags of the indices indicated in the related index candidate list box 1413 are stored as the simulation target flag 0113 shown in FIG. 1 and the acquisition index flags 0312 shown in FIG. 3, respectively, and the processes shown in FIG. 1 from the evaluation value calculation process 0101 to the simulation process 0104 are sequentially activated.

When the cancel button 1417 shown in FIG. 14 is selected, on the other hand, the simulation system shown in FIG. 1 is shut down. It should be noted that the simulation system screen 1401 may be provided with elements other than the target index selection pull-down menu 1411, the index list box 1412, the related index candidate list box 1413, the add button 1414, the delete button 1415, the OK button 1416, and the cancel button 1417.

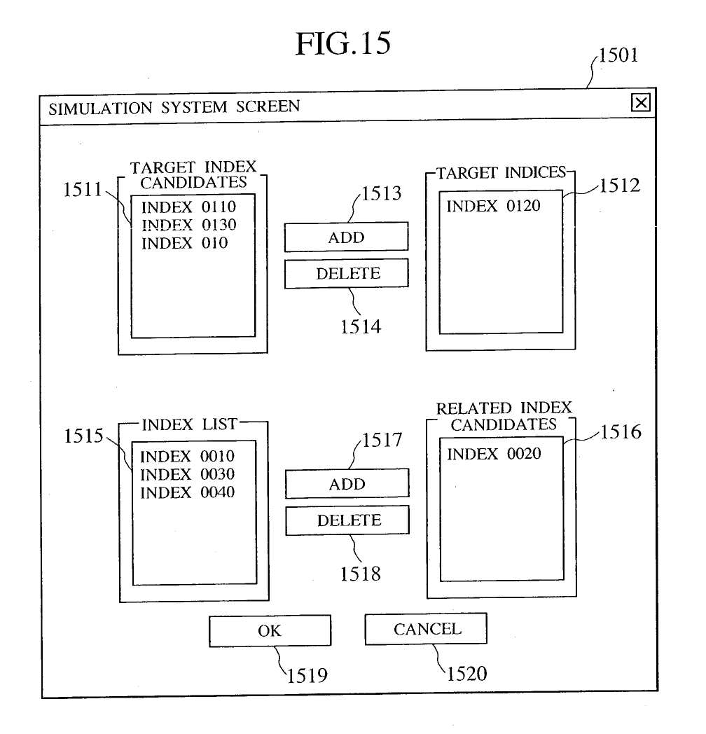

Description will be made below of a fourth embodiment of the simulation system using the simulation method shown in FIG. 1 with reference to FIG. 15.

The fourth embodiment shown in FIG. 15 narrows down related index candidates. Furthermore, the fourth embodiment employs a plurality of target indices (for example, electricity price). First of all, when the simulation system shown in FIG. 1 is started up, the simulation system screen 1501 shown in FIG. 15 is displayed on a computer display (not shown). The simulation system screen 1501 displayed on the display is provided with a target index candidate list box 1511, a target index list box 1512, a target index add button 1513, a target index delete button 1514, an index list box 1515, a related index candidate list box 1516, an add button 1517, a delete button 1518, an OK button 1519, and a cancel button 1520.

When the add button 1513 shown in FIG. 15 is selected (clicked with the cursor) after an index (for example, index 0120) is selected from among the plurality of indices (indices 0100 to 0130) indicated in the target index candidate list box 1511 shown in FIG. 15, the index (for example, index 0120) selected from the target index candidate list box 1511 on the simulation system screen 1501 shown in FIG. 15 is removed from the indices indicated in the target index candidate list box 1511 as a deleted index, and added to the indices indicated in the target index list box 1512 on the simulation system screen 1501 shown in FIG. 15 as an added index.

On the other hand, when the delete button 1514 is selected (clicked with the cursor) after an index (for example, index 0130) indicated in the target index list box 1512 on the simulation system screen 1501 shown in FIG. 15 is selected (clicked with the cursor), the index (for example, index 0130) selected from the target index list box 1512 on the simulation system screen 1501 shown in FIG. 15 is removed from the indices indicated in the target index list box 1512 as a deleted index (in FIG. 15, the index 0130 has already been removed), and added to the indices indicated in the target index candidate list box 1511 as a cancel index again.

When the add button 1517 shown in FIG. 15 is selected (clicked with the cursor) after an index (for example, index 0020) is selected from among the plurality of indices (indices 0010 to 0040) indicated in the index list box 1515 shown in FIG. 15, the index (for example, index 0020) selected from the index list box 1515 on the simulation system screen 1501 shown in FIG. 15 is removed from the indices indicated in the index list box 1515 as a deleted index, and added to the indices indicated in the related index candidate list box 1516 on the simulation system screen 1501 shown in FIG. 15 as an added index.

On the other hand, when the delete button 1518 is selected (clicked with the cursor) after an index (for example, index 0030) indicated in the related index candidate list box 1516 on the simulation system screen 1501 shown in FIG. 15 is selected (clicked with the cursor), the index (for example, index 0030) selected from the related index candidate list box 1516 on the simulation system screen 1501 shown in FIG. 15 is removed from the indices indicated in the related index candidate list box 1516 as a deleted index (in FIG. 15, the index 0030 has already been removed), and added to the index list box 1515 as a cancel index again.

Further, when the OK button 1519 shown in FIG. 15 is selected (clicked with the cursor), the flags of the indices indicated in the target index list box 1512 shown in FIG. 15 and the flags of the indices indicated in the related index candidate list box 1516 are stored as the simulation target flags 0113 shown in FIG. 1 and the acquisition index flags 0312 shown in FIG. 3, respectively, and the processes shown in FIG. 1 from the evaluation value calculation process 0101 to the simulation process 0104 are sequentially activated.

When the cancel button 1520 shown in FIG. 15 is selected, on the other hand, the simulation system shown in FIG. 1 is shut down. It should be noted that the simulation system screen 1501 may be provided with elements other than the target index candidate list box 1511, the target index list box 1512, the target index add button 1513, the target index delete button 1514, the index list box 1515, the related index candidate list box 1516, the add button 1517, the delete button 1518, the OK button 1519, and the cancel button 1520.

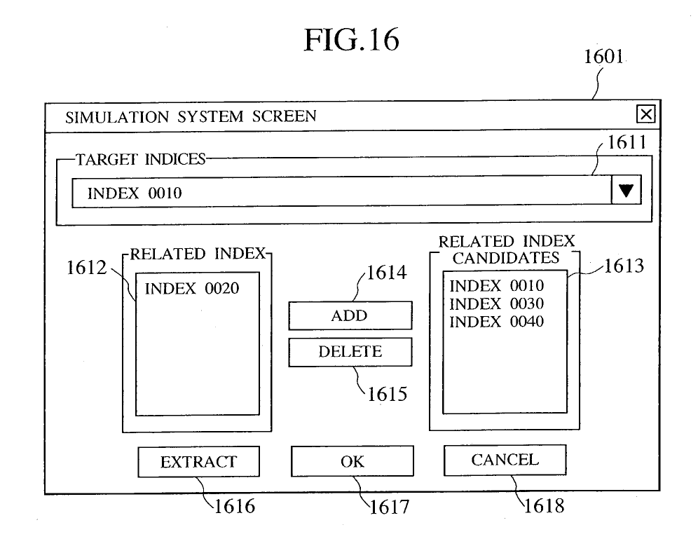

Description will be made below of a fifth embodiment of the simulation system using the simulation method shown in FIG. 1 with reference to FIG. 16.

The fifth embodiment shown in FIG. 16, which employs only a single target index, extracts related indices based on evaluation values and then adds or deletes some related indices to or from them.

First of all, when the simulation system shown in FIG. 1 is started up, the simulation system screen 1601 shown in FIG. 16 is displayed on a computer display (not shown). The simulation system screen 1601 displayed on the display is provided with a target index selection pull-down menu 1611, a related index list box 1612, a related index candidate list box 1613, a delete button 1614, an add button 1615, an extract button 1616, an OK button 1617, and a cancel button 1618.

The target index selection pull-down menu 1611 shown in FIG. 16 makes it possible to select a target index (candidate) from candidate indices.

Further, when the extract button 1616 on the simulation system screen 1601 shown in FIG. 16 is selected (clicked with the cursor), the flag of the index selected in the target index selection pull-down menu 1611 on the simulation system screen 1601 shown in FIG. 16 is stored as the simulation target flag 0113 shown in FIG. 1, and the evaluation value calculation process 0101 and the index selection process 0102 (and the simulation process 0104) shown in FIG. 1 are sequentially activated.

The index (index 0010) extracted in the index selection process 0102 shown in FIG. 1 is indicated in the related index list box 1612 on the simulation system screen 1601 shown in FIG. 16. When the delete button 1614 is selected (clicked with the cursor) after an index (index 0010) indicated in the related index list box 1612 on the simulation system screen 1601 shown in FIG. 16 is selected (clicked with the cursor), the index (index 0010) selected from the related index list box 1612 on the simulation system screen 1601 shown in FIG. 16 is removed from the indices indicated in the related index list box 1612 as a deleted index, and added to the related index candidate list box 1613 on the simulation system screen 1601 shown in FIG. 16 as a related index.

Further, when the add button 1615 is selected (clicked with the cursor) after an index (for example, index 0020) indicated in the related index candidate list box 1613 on the simulation system screen 1601 shown in FIG. 16 is selected (clicked with the cursor), the index (for example, index 0020) selected from the related index candidate list box 1613 on the simulation system screen 1601 shown in FIG. 16 is removed from the indices indicated in the related index candidate list box 1613 (in FIG. 16, the index 0020 has already been removed), and added to the index list box 1612 as a cancel index. This process corresponds to the index extraction process 0803 using the essential related index 0812 and the needless related index 0813 shown in FIG. 8.

Further, when the OK button 1617 on the simulation system screen 1601 shown in FIG. 16 is selected (clicked with the cursor), the flag of the index selected in the target index selection pull-down menu 1611 on the simulation system screen 1601 shown in FIG. 16 and the flags of the indices indicated in the related index candidate list box 1612 are stored as the simulation target flag 0013 shown in FIG. 1 and the extracted-index flags 0821 shown in FIG. 8, respectively, and the parameters estimation process 0103 and the simulation process 0104 shown in FIG. 1 are sequentially activated.

When the cancel button 1618 shown in FIG. 16 is selected, on the other hand, the simulation system shown in FIG. 1 is shut down. It should be noted that the simulation system screen 1601 shown in FIG. 16 may be provided with elements other than the target index selection pull-down menu 1611, the related index list box 1612, the related index candidate list box 1613, the delete button 1614, the add button 1615, the extract button 1616, the OK button 1617, and the cancel button 1618.

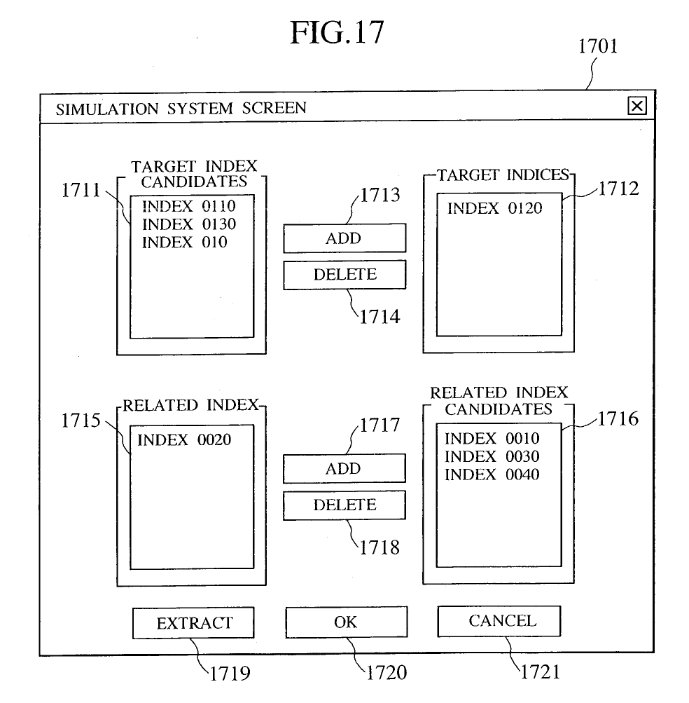

Description will be made below of a sixth embodiment of the simulation system using the simulation method shown in FIG. 1 with reference to FIG. 17.

The sixth embodiment shown in FIG. 17, which employs a plurality of target indices, extracts related indices based on evaluation values and then adds or deletes some related indices to or from them. First of all, when the simulation system shown in FIG. 1 is started up, the simulation system screen 1701 shown in FIG. 17 is displayed on a computer display (not shown). The simulation system screen 1701 displayed on the display is provided with a target index candidate list box 1711, a target index list box 1712, a target index add button 1713, a target index delete button 1714, a related index list box 1715, a related index candidate list box 1716, a delete button 1717, an add button 1718, an extract button 1719, an OK button 1720, and a cancel button 1721.

When the target index add button 1713 shown in FIG. 17 is selected (clicked with the cursor) after an index (index 120) is selected from among the plurality of indices (indices 110 to 130 and 010) indicated in the target index candidate list box 1711 shown in FIG. 17, the index (index 0120) selected from the target index candidate list box 1711 on the simulation system screen 1701 shown in FIG. 17 is removed from the indices indicated in the target index candidate list box 1711 as a deleted index, and added to the target index list box 1712 on the simulation system screen 1701 shown in FIG. 17 as an added index.

On the other hand, when the target index delete button 1714 is selected (clicked with the cursor) after an index (for example, index 0130) indicated in the target index list box 1712 on the simulation system screen 1701 shown in FIG. 17 is selected (clicked with the cursor), the index (for example, index 0130) selected from the target index list box 1712 on the simulation system screen 1701 shown in FIG. 17 is removed from the indices indicated in the target index list box 1712 as a deleted index (in FIG. 17, the index 0130 has already been removed), and added to the indices indicated in the target index candidate list box 1711 as a cancel index again.

Further, when the extract button 1719 shown in FIG. 17 is selected (clicked with the cursor), the flags of the indices indicated in the target index list box 1712 shown in FIG. 17 are stored as the simulation target flags 0113 shown in FIG. 1, and the evaluation value calculation process 0101 and the index selection process 0102 are sequentially activated.

The index (index 0010) extracted in the index selection process 0102 shown in FIG. 1 is indicated in the related index list box 1715 on the simulation system screen 1701 shown in FIG. 17. When the delete button 1714 is selected (clicked with the cursor) after an index (index 0010) indicated in the related index list box 1715 on the simulation system screen 1701 shown in FIG. 17 is selected (clicked with the cursor), the index (index 0010) selected from the related index list box 1715 on the simulation system screen 1701 shown in FIG. 17 is removed from the indices indicated in the related index list box 1715 on the simulation system screen 1701 shown in FIG. 17 as a deleted index, and added to the related index candidate list box 1716 on the simulation system screen 1701 shown in FIG. 17 as a related index.

Further, when the add button 1718 is selected (clicked with the cursor) after an index (for example, index 0020) indicated in the related index candidate list box 1716 on the simulation system screen 1701 shown in FIG. 17 is selected (clicked with the cursor), the index (for example, index 0020) selected from the related index candidate list box 1716 on the simulation system screen 1701 shown in FIG. 17 is removed from the indices indicated in the related index candidate list box 1716 (in FIG. 17, the index 0020 has already been removed), and added to the related index list box 1715 as a cancel index. This process corresponds to the index extraction process 0803 using the essential related index 0812 and the needless related index 0813 shown in FIG. 8.

Further, when the OK button 1720 on the simulation system screen 1701 shown in FIG. 17 is selected (clicked with the cursor), the flags of the indices indicated in the target index list box 1712 on the simulation system screen 1701 shown in FIG. 17 and the flags of the indices indicated in the related index candidate list box 1715 are stored as the simulation target flags 0113 shown in FIG. 1 and the extracted-index flags 0821 shown in FIG. 8, respectively, and the parameters estimation process 0103 and the simulation process 0104 shown in FIG. 1 are sequentially activated.

When the cancel button 1721 shown in FIG. 17 is selected, on the other hand, the simulation system shown in FIG. 1 is shut down. It should be noted that the simulation system screen 1701 shown in FIG. 17 may be provided with elements other than the target index candidate list box 1711, the target index list box 1712, the target index add button 1713, the target index delete button 1714, the related index list box 1715, the related index candidate list box 1716, the delete button 1717, the add button 1718, the extract button 1719, the OK button 1720, and the cancel button 1721.

According to the present invention, a highly accurate simulation can be performed even when the indices related to the index to be simulated change with time (each simulation execution time point).

What is claimed is:

1. A simulation system performing the steps of:
calculating evaluation values each indicating an association degree of one of (a plurality of) indices with a target index, said indices not including said target index;
from among said indices not including said target index, selecting an index (a related index) to be used for simulation of said target index;
estimating (calculating) parameters for said simulation of said target index;
performing said simulation of said target index; and
outputting a result of said simulation.

2. A simulation system performing the steps of:
receiving time-series data of a plurality of indices for an arbitrarily set period;
arbitrarily selecting one or a plurality of indices from among one or a plurality of indices related to an index to be simulated;
for said arbitrarily set period, simulating changes of said index to be simulated and said selected one or plurality of indices related to said index to be simulated by use of a computer; and
outputting a result of said simulation;
wherein said simulation system further performs steps of:
calculating evaluation values each indicating an association degree of one of said received plurality of indices for said arbitrarily set period with said index to be simulated (simulation target); and
selecting an index related to said index to be simulated based on said calculated evaluation values.

3. The simulation system as claimed in claim 2, further performing steps of:
indicating said received plurality of indices on a display device in such a way that said received plurality of indices are selectable; and
selecting an index related to said index to be simulated from among said selectable plurality of indices.

4. The simulation system as claimed in claim 2, further performing steps of:
selecting (a plurality of) indices related to said index to be simulated from among said received plurality of indices;
indicating said selected plurality of indices on a display device;
accepting selection (of an index) from among said indicated plurality of indices; and
performing simulation using said selected index as an index related to said index to be simulated.

5. A simulation method comprising:
an evaluation value calculation step of calculating evaluation values each indicating an association degree of one of (a plurality of) indices with a target index, said indices not including said target index;
an index selection step of, from among said indices not including said target index, selecting an index (a related index) to be used for simulation of said target index;
a parameters estimation (calculation) step of estimating (calculating) parameters for said simulation of said target index;
a simulation step of performing said simulation of said target index; and
a simulation result output step of outputting a result of said simulation obtained at said simulation step.

6. A simulation system performing the steps of:
receiving time-series data of a plurality of indices for an arbitrarily set period;
arbitrarily selecting one or a plurality of indices from among one or a plurality of indices related to an index to be simulated;
for said arbitrarily set period, simulating changes of said index to be simulated and said selected one or plurality of indices related to said index to be simulated by use of a computer; and
outputting a result of said simulation on a display;
wherein a target index selection pull-down menu, an OK button, and a cancel button are provided on said display (screen).

7. A simulation system performing the steps of:
receiving time-series data of a plurality of indices for an arbitrarily set period;
arbitrarily selecting one or a plurality of indices from among one or a plurality of indices related to an index to be simulated;
for said arbitrarily set period, simulating changes of said index to be simulated and said selected one or plurality of indices related to said index to be simulated by use of a computer; and
outputting a result of said simulation on a simulation system screen;
wherein said simulation system screen is provided with a target index selection pull-down menu, an OK button, and a cancel button.

8. A simulation system performing the steps of:
receiving time-series data of a plurality of indices for an arbitrarily set period;
arbitrarily selecting one or a plurality of indices from among one or a plurality of indices related to an index to be simulated;
for said arbitrarily set period, simulating changes of said index to be simulated and said selected one or plurality of indices related to said index to be simulated by use of a computer; and
outputting a result of said simulation on a simulation system screen;
wherein said simulation system screen is provided with a target index candidate list box, a target index list box, an add button, a delete button, an OK button, and a cancel button.

9. A simulation system performing the steps of:
receiving time-series data of a plurality of indices for an arbitrarily set period;
arbitrarily selecting one or a plurality of indices from among one or a plurality of indices related to an index to be simulated;
for said arbitrarily set period, simulating changes of said index to be simulated and said selected one or plurality of indices related to said index to be simulated by use of a computer; and
outputting a result of said simulation on a simulation system screen;
wherein said simulation system screen is provided with a target index candidate list box, a target index list box, an add button, a delete button, an OK button, and a cancel button; and
wherein said simulation system further performs steps of:
arbitrarily selecting an index from among a plurality of indices indicated in said target index candidate list box;
by use of said add button, moving said selected index from said target index candidate list box to said target index list box;
arbitrarily selecting an index from among a plurality of indices indicated in said target index list box; and
by use of said delete button, moving said selected index from said target index list box to said target index candidate list box.

10. The simulation system as claimed in claim 9, further performing steps of:
through selection of said OK button, storing flags of indices indicated in said target index list box as target index flags (simulation target flags) and sequentially starting process steps from an evaluation value calculation step to a simulation step; and
through selection of said cancel button, shutting down said simulation system.

11. A simulation system performing the steps of:
receiving time-series data of a plurality of indices for an arbitrarily set period;
arbitrarily selecting one or a plurality of indices from among one or a plurality of indices related to an index to be simulated;
for said arbitrarily set period, simulating changes of said index to be simulated and said selected one or plurality of indices related to said index to be simulated by use of a computer; and
outputting a result of said simulation on a simulation system screen;
wherein said simulation system screen is provided with a target index selection pull-down menu, an index list box, a related index candidate list box, an add button, a delete button, an OK button, and a cancel button.

12. A simulation system performing the steps of:
receiving time-series data of a plurality of indices for an arbitrarily set period;
arbitrarily selecting one or a plurality of indices from among one or a plurality of indices related to an index to be simulated;
for said arbitrarily set period, simulating changes of said index to be simulated and said selected one or plurality of indices related to said index to be simulated by use of a computer; and
outputting a result of said simulation on a simulation system screen;
wherein said simulation system screen is provided with a target index selection pull-down menu, an index list box, a related index candidate list box, an add button, a delete button, an OK button, and a cancel button; and
wherein said simulation system further performs steps of:
selecting a candidate (an index) from among candidate indices in said target index selection pull-down menu;
storing and indicating a plurality of indices in said index list box;
by use of said add button, moving an index from said index list box to said related index candidate list box and indicating said index, said index being arbitrarily selected from among said plurality of indices indicated in said index list box;
by use of said delete button, moving an index from said related index candidate list box to said index list box and indicating said index, said index being selected in said related index candidate list box;
through selection of said OK button, storing a flag of an index selected in said target index selection pull-down menu as a target index flag (simulation target flag), further storing (flags of) indices indicated in said related index candidate list box as related index flags (acquisition index flags), and sequentially starting process steps from said evaluation value calculation step to said simulation step; and
through selection of said cancel button, shutting down said simulation system.

13. A simulation system employing:
an evaluation value calculation step of calculating evaluation values each indicating an association degree of one of (a plurality of) indices with a target index, said indices not including said target index;
an index selection step of, from among said indices not including said target index, selecting an index (a related index) to be used for simulation of said target index;
a parameters estimation (calculation) step of estimating (calculating) parameters for said simulation of said target index;
a simulation step of performing said simulation of said target index; and
a simulation result output step of, on a simulation system screen, outputting a result of said simulation obtained at said simulation step;
wherein said simulation system screen is provided with a target index selection pull-down menu, an index list box, a related index candidate list box, an add button, a delete button, an OK button, and a cancel button; and
wherein said simulation system performs steps of:
selecting a candidate (an index) from among candidate indices in said target index selection pull-down menu;
storing and indicating a plurality of indices in said index list box;
by use of said add button, moving an index from said index list box to said related index candidate list box and indicating said index, said index being arbitrarily selected from among said plurality of indices indicated in said index list box;
by use of said delete button, moving an index from said related index candidate list box to said index list box and indicating said index, said index being selected in said related index candidate list box;
through selection of said OK button, storing a flag of an index selected in said target index selection pull-down menu as a target index flag (simulation target flag), further storing (flags of) indices indicated in said related index candidate list box as related index flags (acquisition index flags), and sequentially starting said evaluation value calculation step, said index selection step, said parameters estimation step, and said simulation step; and
through selection of said cancel button, shutting down said simulation system.

14. A simulation system performing the steps of:
receiving time-series data of a plurality of indices for an arbitrarily set period;
arbitrarily selecting one or a plurality of indices from among one or a plurality of indices related to an index to be simulated;
for said arbitrarily set period, simulating changes of said index to be simulated and said selected one or plurality of indices related to said index to be simulated by use of a computer; and
outputting a result of said simulation on a simulation system screen;
wherein said simulation system screen is provided with a target index candidate list box, a target index list box, a target index add button, a target index delete button, an index list box, a related index candidate list box, an add button, a delete button, an OK button, and a cancel button;
wherein said simulation system further performs steps of:
selecting a candidate (an index) from among candidate indices in said target index selection pull-down menu;
storing and indicating a plurality of indices in said index list box;
by use of said add button, moving an index from said index list box to said related index candidate list box and indicating said index, said index being arbitrarily selected from among said plurality of indices indicated in said index list box;
by use of said delete button, moving an index from said related index candidate list box to said index list box and indicating said index, said index being selected in said related index candidate list box;
through selection of said OK button, storing a flag of an index selected in said target index selection pull-down menu as a target index flag (simulation target flag), further storing (flags of) indices indicated in said related index candidate list box as related index flags (acquisition index flags), and sequentially starting process steps from said evaluation value calculation step to said simulation step;
through selection of said cancel button, shutting down said simulation system.

15. A simulation system employing:
an evaluation value calculation step of calculating evaluation values each indicating an association degree of one of (a plurality of) indices with a target index, said indices not including said target index;
an index selection step of, from among said indices not including said target index, selecting an index (a related index) to be used for simulation of said target index;
a parameters estimation (calculation) step of estimating (calculating) parameters for said simulation of said target index;
a simulation step of performing said simulation of said target index; and
a simulation result output step of, on a simulation system screen, outputting a result of said simulation obtained at said simulation step;
wherein said simulation system screen is provided with a target index candidate list box, a target index list box, a target index add button, a target index delete button, an index list box, a related index candidate list box, an add button, a delete button, an OK button, and a cancel button; and
wherein said simulation system performs steps of:
selecting an index from among a plurality of indices indicated in said target index candidate list box;
through selection of said add button, moving said index selected in said target index candidate list box from said target index candidate list box to said target index list box and indicating said index;
selecting an index indicated in said target index list box;
through selection of said delete button, moving said selected index from said target index list box to said target index candidate list box and indicating said selected index;
selecting an index from among a plurality of indices indicated in said index list box;
through selection of said add button, moving said index selected in said target index list box from said target index list box to said related index candidate list box and indicating said index;
selecting an index indicated in said related index candidate list box;
through selection of said delete button, moving said selected index from said related index candidate list box to said index list box and indicating said selected index;
through selection of said OK button, storing flags of indices indicated in said target index list box as target index flags (simulation target flags), further storing (flags of) indices indicated in said related index candidate list box as related index flags (acquisition index flags), and sequentially starting said evaluation value calculation step, said index selection step, said parameters estimation step, and said simulation step; and
through selection of said cancel button, shutting down said simulation system.
